(19) United States
(12) Patent Application Publication
(10) Pub. No.: US 2010/0235270 A1
(43) Pub. Date: Sep. 16, 2010

(54) Apparatus, system and method for a precious coin exchange platform and for valuation and trade of precious coins

(76) Inventor: David N. Baker, Bend, OR (US)

Correspondence Address: Drinker Biddle & Reath LLP, One Logan Square, 18th and Cherry Streets, Philadelphia, PA, 19103-6996, US

(21) Appl. No.: 12/383,820

(22) Filed: Mar. 27, 2009

Related U.S. Application Data
(60) Provisional application No. 61/210,191, filed on Mar. 12, 2009.

(51) Int. Cl. G06Q 20/00; G06F 17/30

(52) U.S. Cl. 705/35; 707/E17.044; 707/E17.108

(57) ABSTRACT

An apparatus, system and method for buying and selling interests in at least one coin pool. The apparatus, system and method includes an assessment of at least one coin for inclusion in the at least one coin pool, wherein the at least one coin constitutes legal tender in at least one country, principally precious metals selected from the group of gold, silver, platinum, palladium, and rhodium, an international mintage of less than 10,000, a national mintage limit of at least one of no more than a predetermined threshold mintage and a production limit in a certain timeframe, a non-business strike, a non-bullion, and a proof. The present invention may additionally include a valuing of the at least one coin for a buy in accordance with at least one of a currency exchange value, an award, and a projected value increase, a purchasing of the at least one coin and placing the at least one coin into the at least one pool in accordance with the assessing and the valuing, and an offering of the interests in the coin pool in accordance with said purchasing.

### BACKGROUND OF THE INVENTION

1. Field of the Invention

The instant invention relates to the field of valuation and trading of precious coins, and more particularly to an apparatus, system and method for a precious coin exchange platform, and for valuation and trade of precious coins.

2. Description of the Background

In today's world, the majority of investable instruments are in the form of securities, and are overseen, in the United States, by the Securities and Exchange Commission, and in other nations by equivalent bodies.

Securities are typically traded within a financial market that provides a platform having a high level of liquidity, such that investors may easily buy, sell and similarly trade these financial securities. One of the advantages of a financial market is that it creates an environment for trading at low transaction costs, and at prices that better reflect the current, actual value of the securities traded.

Markets work by placing interested buyers and sellers in one “place”, thus making it easier for them to find each other. Financial markets have evolved significantly over the past several hundred years, and are undergoing constant innovation to improve features of liquidity. There are many different types of financial markets. For example, in the realm of commodities trading, there are general markets, where many commodities are traded, and there are specialized markets, where only one commodity is traded.

In an exemplary embodiment of a commodity market, gold is one of the world's most traded and tradable commodities. Investment in gold can be done directly through bullion or coin ownership, or indirectly through certificates, accounts, spread betting, derivatives or shares, by way of limited example.

As is the case with typical markets, the gold market may experience a “bull,” meaning favorable, trading condition, or a “bear,” meaning unfavorable, trading condition. However, the relationship between conditions to trade in and bull and bear markets, and the underlying instruments on which trade is based, may not necessarily be one-to-one. For example, gold stocks and funds are not necessarily the best “play” in a gold bull market. More specifically, should a gold bull market arise amidst bearish stocks, as the majority of major brokerages have recently predicted, an investor might logically assume that all tradable instruments directly related to gold would likewise become the subject of a bull market. This is simply not the case, at least in part because, as past market history has shown, such as in 1987, gold stocks do not necessarily march in lockstep with the physical metal, gold.

In the devastating “Black October” of 1987, the Dow Jones Industrial Average (“Dow” or “DJIA”) fell 41%, from 2746 to 1616. Meanwhile, the XAU, which is the index of gold stocks, fell 46%, from 157 to 84. However, the price of physical gold in that same time period rose more than 18%. The devastated XAU index ended the following year, 1988, virtually unimproved, while the Dow had recouped nearly half of its crash of 1987 losses by the close of 1988, enroute to the greatest stock bull market in history. In fact, over the past 26 years, the Dow has declined at least 10% a total of 25 times, and during those same 25 periods gold stocks declined an even greater percentage and for a longer period of time.

Nonetheless, physical bullion demonstrates a better separation, or diversification, for the Dow than gold stocks. This is not particularly surprising, in part because physical gold cannot vanish through creative accounting or forward selling, nor can a company president mismanage away physical gold. In fact, it has been said that there is nothing more honest and secure than gold in one's hand.

However, while gold bullion has had an impressive record of profitability since the mid-70's, the record of gold pales in comparison to investment in rare coins. In comparison to gold bullion, the historical performance of numismatic coins reveals such coins experience a magnification of any positive market effects are experienced by gold bullion. For example, a $1000 basket of gold mint state, rare, numismatic coins, from 1970 is today worth a stunning $57,977.

Therefore, a need exists for an apparatus, system and method for a precious coin exchange platform, and for valuation and trade of precious coins.

### SUMMARY OF THE INVENTION

The present invention provides an apparatus, system and method for buying and selling interests in at least one coin pool. The apparatus, system and method includes an assessment of at least one coin for inclusion in the at least one coin pool, wherein the at least one coin constitutes legal tender in a country of origin of the at least one coin, principally precious metals selected from the group of gold, silver, platinum, palladium, and rhodium, and at least one of an international mintage of no more than about 10,000, a national mintage of no more than a predetermined limit or minting timeframe, and most preferably of no more than about 35,000, a non-business strike, a non-bullion, and a proof, a proof-like, a specimen quality or a brilliant-uncirculated. The present invention may additionally include a valuing of the at least one coin for a buy in accordance with at least one of a currency exchange value, spot metal price, an award, and a projected value increase, a purchasing of the at least one coin and placing the at least one coin into the at least one pool in accordance with the assessing and the valuing, and an offering of the interests in the coin pool in accordance with said purchasing.

Therefore, the present invention provides an apparatus, system and method for a precious coin exchange platform, and for valuation and trade of precious coins.

### BRIEF DESCRIPTION OF THE FIGURES

Understanding of the present invention will be facilitated by consideration of the following detailed description of the embodiments of the present invention taken in conjunction with the accompanying drawings, in which like numerals refer to like parts and in which:

FIG. 1 illustrates an exemplary overview of the system of the present invention; and

FIG. 2 illustrates an exemplary process by which the system of FIG. 1 operates.

### DETAILED DESCRIPTION OF THE INVENTION

It is to be understood that the figures and descriptions of the present invention have been simplified to illustrate elements that are relevant for a clear understanding of the present invention, while eliminating, for the purpose of clarity, many other elements found in typical coin valuation and exchange mechanisms. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art. Furthermore, the embodiments identified and illustrated herein are for exemplary purposes only, and are not meant to be exclusive or limited in their description of the present invention.

The present invention, in part, includes an apparatus, system and method relating to an investment vehicle and exchange platform that provides fungible ownership of coin pools that can be valued and traded in real-time. Herein, “coin,” “pool,” “pools,” “coin pools,” may, in certain instances, be used interchangeably, and may indicate a tradable, securitizable, or like instrument or vessel in accordance with the present invention. The advantages of such a system are numerous. For example, according to the CU 3000 Index, which is a comprehensive index on the overall price movement of the rare coin market and is the standard of numismatic coin performance, a $1,000 investment in a “basket” of generic gold coins purchased in 1970 was recently valued at $22,500. In contrast to this, a $1,000 coin portfolio of mint state, gold coins grew in value over that same time to over $57,977. In further contrast, a $1,000 investment in the Dow 30 in 1970 is now worth approximately $13,500.

Furthermore, over fifteen recessions experienced in the U.S. since 1919, numismatic rare coins have performed particularly well as compared to other investment options. For example, during the period from 1981 to 1989, which is a time most noted for the end of a recession and the nightmarish stock crash of 1987, the CU 3000 Rare Coin index increased in value by an astounding 660%. This is an important trend, particularly since bear markets for most investments tend to last approximately one-third to one-half as long as any preceding bull market. For example, the bear market following the Great Crash of 1929 lasted half as long as the preceding bull market, yet it still took 25 years for investors to break even. Likewise, the 1973-74 bear market for stocks lasted just two years, but the average investor who suffered through it would not break even for another 12 years.

Additionally, diversification into precious metals has traditionally been used strategically to offset the negative effects of an uncertain economy, and/or a bull market, on paper investments. Precious metal coins are no exception to this strategy, but the present state of the art does not provide a mechanism for the typical investor to benefit from this unique combination investment vehicle, namely precious metals and rare coins.

Presently, the only way for coin collectors and investors to exchange coins is via an archaic “trading network” methodology. For example, the Dealer Trading Network is an organization of coin buyers and sellers that communicates bid and ask prices for numismatic coins each day. At any given time, coin dealers can provide buy or sell quotes using this trading network for almost any coin, thus endeavoring to provide comparable liquidity to other traditional investment markets. This trading network forms the backbone of the current coin market. However, while this trading network does provide a limited amount of liquidity for the coin market, this liquidity is entirely based upon independent grading sources, such as the Numismatic Guaranty Corporation (NGC) and the Professional Coin Grading Service (PCGS). These grading services have established a generally accepted standard for individual coin grading. As such, once assigned a grade by one or both of these services, a typical graded coin may be considered for purchase or sale. Further, modern world coins are often not graded and may or may not be part of typical dealer-to-dealer networks. Thus, modern world coins often have their value based on other criteria, making the present invention particularly useful for valuing and trading modern world coins.

Other exchange systems for coins include coin auctions. Auctions take advantage of the intangible features imposed by collectors, who search for the more unique coins having lower mintage, particular themes, special technologies such as holograms and laser technologies, or modern world coins needed to complete collections. This can artificially raise the bidding on auctioned coins far beyond market forces in other avenues of liquidation. For example, the famous Eliasberg Coin Collection was a major event that fetched over $30 million for unique, one-of-a-kind coins.

Additionally, there are numerous websites that sponsor a more informal type of coin auction. In these on-line auctions, participants need not travel to an actual location on a given day. Instead, participants can typically view auctioned coins online and then bid for the coins over a several day period. In part because on-line auctions present a more “bid-friendly” type of auction, at least in that such auctions do not draw the same high prices as live auctioning, these on-line forums have increased the size and scope of the coin market. Other organizations, such as Lear Capital, provide a private network of gold dealers that can exchange coins. While Lear Capital and other Internet based trading platforms may monitor existing grading services, their information retrieval mechanisms are limited, and are not conducive to real-time updates of appraisals and events that may ultimately change the value of modern world, numismatic coins. Furthermore, such mechanisms remain fixed to the exchange of the physical coins, and do not present an opportunity for non-collectors, or less extensive collectors, to reap the benefits of owning at least a portion of a precious coin collection.

In a world of full financial disclosures, extensive reporting requirements, and constant monitoring, precious coins enjoy individual privacy. Currently, rare coins are one of the few remaining investments that may be accumulated privately and in a confidential manner. In other words, rare coins, including modern and old world coins, are one of the least visible forms of wealth, and so, by investing in coins, investors may not need to publicly reveal aspects of wealth. This is in stark contrast to banks and brokerages, which require extensive disclosure of client information to governmental agencies, and which, in some instances, sell personal information to marketers. Furthermore, there are no 1099B forms or other items filed when one buys or sells pre-1933 investment coins, for example.

Unlike other types of investments, coins are “multi-factoral” in their ability to appreciate in value. In other words, the coin market provides multiple ways to profit. For example, the price of a coin can increase as the value of the precious metal comprising the coin also increases, often at a rate of increase greater than the underlying precious metal. In another example, the price of the coin can also increase as its collector premium increases. Collector premiums take advantage of intangible features, such as the rarity and quality of a coin. Examples of coins having multi-factoral appreciation are the famous St. Gaudens $20 gold piece, the $5.00 incuse Indian, the Morgan Silver Dollar, the Peace Dollar, and modern world coins, such as the Coco Chanel and the 2008 UK Queen Elizabeth I £5 Platinum Proof Coin, by way of non-limiting example. These are all examples of beauty, rarity, and inherent precious metal value. Not only do these intangible factors help put a “floor” on the value of coins, but they also provide an additional stimulus to the value of a coin when the gold, silver or other precious metal within it rises.

With new streams of demand being supplied via exposure of precious coins and an expanding base of coin collectors, investors, and dealers, the competition for the “fixed supply” of precious coins is a breeding ground for a market-driven investment vehicle. It is also well documented that the rising value of coins is not dependent on precious metal prices. For example, in 1994, gold fell to $325 per ounce, while an MS63 $20 Liberty coin soared to over $1,000, which was approximately a 30% gain.

Furthermore, coins are understood to be one of the most tax-favored investment vehicles. Any capital gains on coins are usually taxed at liquidation, when profits are realized. There is generally no taxation on phantom or undistributed profits, as with some investments. For example, one coin can be traded for another coin at a “profit” without incurring a tax liability. Additionally, one can actively “trade-up” a coin portfolio with the advantage of holding 100% of the potential profit in the investment. Based just on the potential tax benefits, coins may produce a 60% better growth rate than stocks over a given 10 year period.

Overview

According to an aspect of the present invention, there is provided a software platform and/or web-based portal that may be adapted to obtain, control, maintain, and coordinate various investment methodologies for precious coins, preferably those that have a multi-factorial mode of appreciation, and thus a monetary value based on both tangible and intangible variables. The present invention is thereby directed, in part, to the creation, management and coordination of secure ownership interests of coin pools over a global computer network, wherein the coins within each pool may fit within a set of ownership rules or guidelines for each pool.

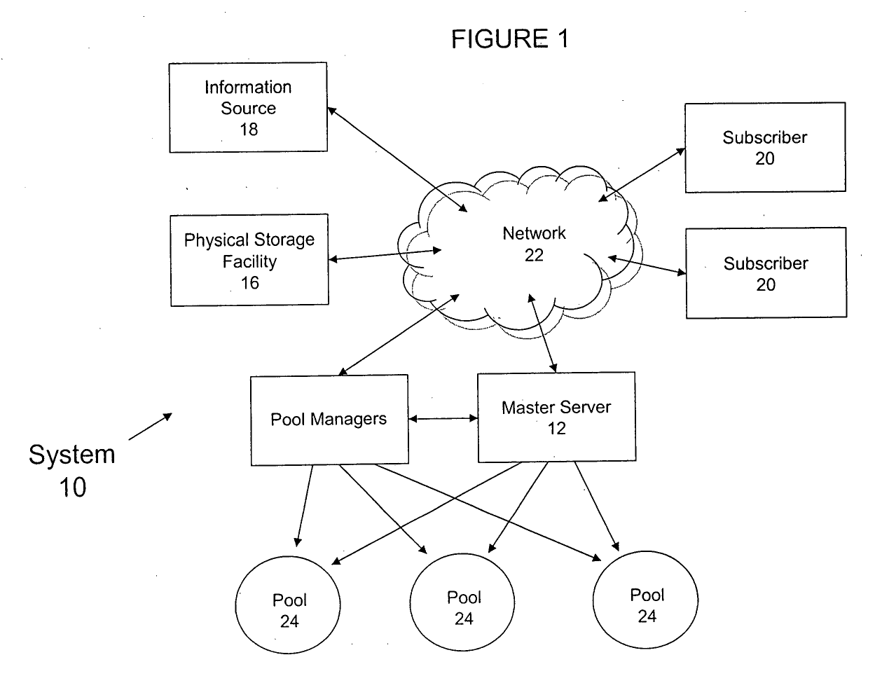

As illustrated in FIG. 1, an overview of the aforementioned system is provided. System 10 may include at least one master server 12 that is communicatively connected to one or more electronic remote databases 14, and at least one physical storage facility 16. As used herein, a “database” or a “relational database” is or includes a data storage vehicle in which one or more data elements may be populated and/or correlated with one or more other data elements, in order to not only store such data elements, but additionally in order to draw conclusions and/or inferences with regard to the data stored. Also connected to master server 12 may be a plurality of Information sources 18. At least one subscriber 20 to a software platform may be made available via Master Server 12. Further, system 10 may create and provide high level management of any number of pools 24, each of which pools may include one or more precious coins or coin types, and each of which may or may not be managed by a pool 24 manager. Pool 24 managers may also be communicatively connected to master server 12 and their respective managed pool 24.

Master server 12 may include specialized software architecture and may be run by a system 10 administrator or administration staff, and may include at least one processor, and standard input and output devices, as well as all hardware and software typically found on computing devices for storing data and running programs, and for sending and receiving data over a network. Master server 12 may be one server or, more preferably, a combination of scalable servers, providing functionality as a network mainframe server, a web server, a mail server and central database server, all maintained and managed by the system 10 administrator. Master server 12 may also be connected directly or via a network to remote database 14, such as for additional storage backup.

Master server 12 may be connected to any number of physical storage facilities 16, information sources 18, and subscribers 20, all via a wide area network 22, such that wide area network 22 allows for the communication of files, email, software, and any other data format between master server 12 and physical storage facilities 16, information sources 18, and subscribers 20. Additionally, the system 10 administrator may add any number of servers or other necessary hardware and software to master server 12, such as to allow system 10 to provide efficient and reliable service, as the number of subscribers 20 may exponentially increase.

Subscribers 20 may be one or more individuals or entities registered with system 10 and using any sort of computing device suitable for uploading and downloading data via wide area network 22. For example, such computing device may be a personal computer (“PC”), a personal digital assistant (“PDA”), a laptop, a wireless digital/cellular phone, or the like.

Information source 18 may be any electronic feed of information relating to either coins held by system 10, or coins of interest not yet owned by system 10. For example, such information sources may be registered or non-registered coin collectors, experts, auctions, agencies, electronic searches or search results, electronic databases, organizations or companies involved in coin appraisal, collection and/or minting. In other embodiments, information source 18 may also be news feeds, RSS feeds, or the like, through which information related to any particular coin might be extracted by a web crawler, web spider, or similar manually activated or automated search method or system. Information source 18 may therefore provide additional information or data related to any aspect of any precious coin that is publicly or commercially available. This information or data may be in any format transferable over wide area network 22, and may be requested or accessed by master server 12 as needed, pursuant to a certain time frame, pursuant to a certain repetition, or as agreed to between managers of both master server 12 and information source 18.

Wide area network 22 may be any suitable networked system understood by those having ordinary skill in the art, such as, for example, an open, wide area network (e.g., the internet), an electronic network, an optical network, a wireless network, a physically secure network or virtual private network, and any combinations thereof. Wide area network 22 may also include any intermediate nodes, such as gateways, routers, bridges, internet service provider networks, public-switched telephone networks, proxy servers, firewalls, and the like, such that wide area network 22 may be suitable for the transmission of data throughout system 10.

An encryption standard may also be used to protect files from unauthorized interception over the network. Any encryption standard or authentication method as may be understood by those having ordinary skill in the art may be used at any point in system 10. For example, encryption may be accomplished by master server 12 encrypting the output file by using a Secure Socket Layer (SSL) with dual key encryption, since a high degree of security may be desired by physical storage facilities 16, information sources 18, or subscribers 20. Additionally, system 10 may limit, for example, data manipulation, or information access. For example, a system 10 administrator may allow for administration at one or more levels, such as at an individual user level, or at a system level. The system 10 administrator may also implement access or use restrictions for users at any level. Such restrictions may include, for example, the assignment of user names and passwords that allow the use of the present invention, or the selection of one or more data types that the subservient user is allowed to view or manipulate.

Further, wide area network 22 may also use standard architecture and protocols as understood by those skilled in the art, such as, for example, a packet switched network for transporting information and packets in accordance with a standard transmission control protocol/Internet protocol (“TCP/IP”). All participants of system 10 may be communicatively connected into wide area network 22 through, for example, a traditional telephone service connection using a conventional modem, an integrated services digital network (“ISDN”), a cable connection including a data over cable system interface specification (“DOCSIS”) cable modem, a digital subscriber line (“DSL”), a T1 line, or any other mechanism as understood by those skilled in the art. Additionally, system 10 may utilize any conventional operating platform or combination of platforms, and may utilize any conventional networking and communications software as needed.

Software Description

As mentioned previously, system 10 further includes application software architecture, which may be managed by master server 12. The software architecture may include a software framework that optimizes ease of use of at least one existing software platform, and that may also extend the capabilities of at least one existing software platform. The application architecture may approximate the actual way users organize and manage coin collection as well as investment data, and thus may organize use activities in a natural, coherent manner while delivering use activities through a simple, consistent, and intuitive interface within each application and across applications. The architecture may also be reusable, providing plug-in capability to any number of applications, without extensive re-programming, which may enable parties outside of system 10 to create components that plug into the architecture. Thus, software or portals in the architecture may be extensible, and new software or portals may be created for the architecture by any party.

The software architecture may provide, for example, applications accessible to one or more users, including subscribers 20 and pool 24 managers, to perform one or more functions, such as a buy, a sell, a trade, or a change in pool or pools, for example. Such applications may be available at the same location as the user, or at a location remote from the user. Each application may provide a graphical user interface (GUI) for ease of interaction by the user with information resident in system 10. A GUI may be specific to a user, set of users, or type of user, or may be the same for all users or a selected subset of users. The software architecture may also provide a master GUI set that allows a user to select or interact with GUIs of one or more other applications, or that allows a user to simultaneously access a variety of information otherwise available through any portion of system 10.

The software architecture may also be a portal that provides, via the GUI, remote access to and from the present invention. Thus, the software architecture may include, for example, a network browser, as well as a trading platform, as is understood by those skilled in the art. Additionally, the software architecture may include the ability, either automatically based upon a user request in another application, or by a user request, to “hook”, search, or otherwise retrieve particular data from one or more remote points, such as on the internet or via the master server 12 databases or database 14. The software architecture may vary by user type, or may be available to only certain user types, depending on the needs of system 10. Users may have some portions, or all of the software architecture, resident on the users' respective computing devices, or may simply have linking mechanisms, as understood by those skilled in the art, to link those users' computing devices to the software architecture running on master server 12 via wide area network 22. As such, any device having, or having access to, the software architecture may be capable of uploading, or downloading, any files, or informational files to be associated with such files. The software architecture may also be provided separately and/or run separately on any computing device of the aforementioned users, providing all functionality applicable to such devices as may be appropriate until actual connection to wide area network 22 (and consequently master server 12) is achieved.

Presentation of data through the software architecture may be in any sort and number of selectable formats. For example, a multi-layer format may be used, wherein additional information is available by viewing successively lower layers of presented information. Such layers may be made available by the use of drop down menus, tabbed pseudo-manila folder files, or other layering techniques understood by those skilled in the art. Formats may also include AutoFill functionality, wherein data may be filled responsively to the entry of partial data in a particular field by the user. All formats may be in standard readable formats, such as XML. The software architecture may further incorporate standard features typically found in investment trading applications, such as, for example, account summaries, charts, pool 24 and/or coin profiles, and the like. The software architecture may also support a live streaming feed, or any sort of “live feed” streamed to users, such as real-time quotes, foreign exchange rates, precious metal prices, interest rates, and the like. Because the aforementioned users, such as subscribers 20 and pool 24 managers, may access master server 12 via a mobile device, such as a wireless phone or pda, streaming data may be passed throughout wide area network 22 as needed between towers, or by any other method understood by those skilled in the art. The software architecture may also support any sort of interactive purchasing platform, where a user may receive advertisements and purchase items from system 10 or from any third party connected to system 10 via wide area network 22.

Coin Identification and Classification

System 10 may use any sort of screening or quality assurance methodology for determining which coins may or may not be purchased for inclusion into the pools 24 of system 10. By way of non-limiting example only, coins for inclusion into system 10 may have one, several, or all of the following characteristics:

The coin must be or have been legal tender in the country in which or for which the coin was minted at the time of purchase;

The coin must consist principally or almost entirely of precious metals. For example, the purity level of precious metals of each coin must be no less than 90% pure gold, silver, platinum, palladium, rhodium or other precious metal, or combination thereof, whether it be a bi-metal, alloy or clad coin, by way of non-limiting example. If the coin is bi-metal, alloy or clad, then no more than 10% may be a base metal, such as nickel or copper;

In the case where there is a gemstone on the coin, the gemstone may generally weigh no more than about 1 gram, or a certain threshold percentage of a total coin weight. Alternatively such a gem weight threshold may be increased or decreased to any level apparent to those skilled in the art.

No more than 10,000 of each coin may be minted if international (for countries or Mints located outside the United States), and no more than a certain threshold, such as 100,000 or 50,000, of each coin may be minted within the United States. More preferably, no more than 35,000 of each coin may be minted within the United States;

The coin is neither a “business strike”, which means the coin was minted for general circulation, nor a circulation or high circulation precious metal “bullion” coin. As used herein, a “bullion coin” means a precious metal coin traded at current bullion prices, and optionally in general circulation or previously circulated.

The coin may or may not be a Proof coin. As used herein, a “Proof coin” is one of specially burnished blanks used by a mint, and which may have higher luster and/or, typically, a double strike or triple strike on the coin, which makes the coin possess a higher relief, higher polish, higher contrast, a mirror like finish in the “field” of the coin, and frosted look to the “relief” area of the coin. If the coin is not a proof coin, it may be of varying degrees less than proof. In one example, the coin may be “proof-like.” In another example, the coin may be “specimen quality.” In yet another example, the coin may be “brilliant uncirculated.”

The coin may currently be “uncirculated.” As used herein, “uncirculated” means the coin is not in use in everyday commerce. Being uncirculated does not negate the fact that the coin could ultimately be used in commerce, because it is legal tender and accepted as legal tender, but rather means that such use would be exceedingly rare or undesirable because of the coin's actual value being greater than its intrinsic value and/or its denominational face value. As used herein, a coin's “intrinsic value” means the weight of the coin multiplied by the spot precious metal price.

It should be appreciated that other characteristics may be used to determine which coins may be included within system 10. Furthermore, there is no requirement that any particular characteristic of the aforementioned characteristics be used for screening coins, or that any of the applied screening characteristics be used individually or in any particular combination.

Collection of Information

As explained herein, system 10 may collect any sort of information deemed useful by system 10 in determining the value of a particular coin. By way of non-limiting example, information related to the coins held by system 10 or of interest to system 10 may include a common or trade name of each coin, an internal identifier designated by system 10 upon entry of the coin to the system, the origin of the coin, year, denomination, Mint, composition, quality, fineness, structure, weight, diameter, thickness, proof, proof-like, fineness, circulation, brilliant uncirculated, specimen quality, mintage limit, actual mintage, theme, sub-theme, sub-sub-theme, awards, current status such as “sold out” or “mint ceasing production”, historical prices paid, estimated value, current value, metal value, spot prices, collector value, collector premium, the history of the coin, the current location of the coin, governmental changes, news feeds, the physical description of the coin, coin structure, the age of the coin, the environment and environmental characteristics in which the coin is being stored, the previous owner(s) of the coin and any additional or general information relating to the coin (such as, for example, an explanation of why the coin is valuable, a comparative description of similar coins available and their values, a description of industry standards or expert evaluations, governance requirements over the coin, the extent and scope of reproduction rights, or a description of the physical state and condition of the coin), and any administrative information, including internal system 10 costs associated with the coin.

As explained previously, information may be obtained via information sources 18, or via other standard research methods, and entered into system 10 as understood by those skilled in the art. Information may include, for example, information relating to precious coins, including those information items identified hereinthroughout, such as providing quantitative metrics, such as precious metal value or foreign exchange rates, or such as providing qualitative metrics, such as coin theme or subject matter, or such as providing correlative metrics, such as events indicating a change in valuation.

In one exemplary embodiment, information may be obtained through an upload system adapted to allow the identified coin holder the ability to either electronically or manually upload information relating to the coin into system 10. For example, the identified coin holder may upload physical pictures or representations of the coin, including hard entry of any of the features of the coin as described above. System 10 may provide any sort of survey form for ease of use to upload relevant information. Any information presented to system 10 via an upload or a survey may be reviewed by a system 10 manager and optionally be used in obtaining an estimated value or coin ranking. In any review process utilized by system 10, the system 10 manager may compare the newly provided information with that already existing in the databases of system 10. Consistent data may provide more confidence in the information, and thus may reduce any risk value associated with the information on a particular coin. Likewise, inconsistent data may create a warning, or “red flag” alert, which signals to the system 10 manager that such inconsistency exists.

Similarly, information may be gained through the use of a web-crawl, a search spider, a RSS feed crawler, a news crawler, a valuation crawler, a keyword alert system, currency fluctuation comparators, or the like, as will be understood by those skilled in the art. For example, due to the extraordinary value attribution given a coin in the event that coin wins an award, a web crawl may be performed to associate any award, in approximately real time, with the coin that has won that award. Thereby, a value association can be heuristically defined, such as based on past history of coins winning the same, or a similar, awards, including a likely timeframe and percentage for any attendant increase in value based on the award. Such a heuristically defined value increase, and time frame, can allow for a projection of whether the award winning coin, and/or its associated pool, is a recommended buy for an automated buying engine associated with the master server, and for how long such coin or pool is a recommended buy. Similarly, fluctuations in the relative value of various currencies may affect the value of coins associated with particular countries. For example, the strengthening of a particular country's currency versus the U.S. dollar may, through the use of system 10, make that nation's collectible coins a recommended buy during the upward valuation of that country's currency. Likewise, a weakening of a currency could trigger a recommendation to sell. In a manner similar to the information uploads discussed previously, information presented to system 10 via a search mechanism may be reviewed by a system 10 manager, and/or may optionally be used in obtaining an estimated value or coin ranking. The system 10 may compare the newly provided information with that already existing in the databases of system 10. Consistent data may provide more confidence in the information, and thus may reduce any risk value associated with the information on a particular coin or coins. Likewise, inconsistent data may generate a warning.

System 10 may further provide a high-level management of each pool 24, as well as the horizontal interactions between pools 24, and provide pool 24 managers with real-time access and updates to the information as it relates to each and every coin monitored in system 10. Further, system 10 may provide high level monitoring of any information as it relates to the pools. In other words, it may provide to the pool manager that information which is a collection or compilation of any and all coins designated as being part of the pool. It should be appreciated that as information for a particular coin is received by system 10 and that information invoked, a new estimated value for that coin may be generated, a buy or sell of that coin or its associated pool may be made, and the information for the pool in which that coin sits may similarly be updated and reflected in the valuation of the pool.

System 10 may display not only historical information, including charted grading and appraisal values as a function of time, but may also assist one or more pool 24 managers by presenting such collected data in a format designed for investors, such as charts, graphs, correlation coefficient charts, and the like. System 10 may optionally present recommendations or solutions relating to buying and/or selling of certain coins not yet held by system 10, or with those coins already positioned within a pool 24.

Valuation Methods

System 10 may calculate and store one or more values for any particular coin in or tracked by system 10. This may include standard value estimating and appraisal methods as is understood by those skilled in the art, or it may use those novel valuation mechanisms described herein, or it may utilize any combination of valuation methodologies. Any form of valuation may also be performed by a third party independent of system 10. In one exemplary embodiment, system 10 may obtain grading information and appraisal values from recognized coin experts or organizations either connected via network 22, or by manual collection of such information by individuals that is later uploaded into the databases of system 10, or by heuristically projecting valuation using information automatically populated into the databases of system 10 from automated web crawls and compared with historic valuation information. In another exemplary embodiment, system 10 may define a value based upon the average of all collected appraisal datasets. System 10 may also collect any authenticity or verification data from recognized appraisers. This information may come in form verification letters, opinion letters, coin description letters or certificates of authenticity, all of which may justify previous or current value evaluations. If the coin in question is not actually held in system 10 storage vaults, the system may obtain and store information related to the physical location of the coin, and to track any physical location changes of the coin.

For example, because the coin market is so large, system 10 may have a large valuation/auction/consignment house value the coin or coin collections, on any time frame, such as daily or weekly, for example. In one embodiment, Heritage Auctions, which is the biggest coin auction house in the world, may perform the valuation, with information entered, or downloaded, such as daily, therefrom. Alternatively valuations may be performed originally or supplemented by, for example, the Krause Neumismaster World Coin Pricing Guide, or by auction or recent sales data.

In another embodiment, system 10 may, after obtaining any prerequisite permissions, access the electronic databases of recognized experts to obtain the most recent grading and appraisal values of the coins in question. As multiple valuation sources may be used, information may overlap, and thus system 10 may record and identify any duplicate information and alert to any inconsistencies in the collected information. Each grading and appraisal dataset obtained by system 10 may be stored in the system 10 databases.

Because the value of a coin ultimately rests in the physical possession of the coin, obtaining and maintaining track of the location of each coin is a critical feature of system 10. All appraisal values should preferably be certified or justified in some manner so as to prevent fictitious or made-up values, and to preserve the accuracy of the appraisal value. In some embodiments, system 10 may require physical possession of any coins or certificates, and/or ratify the accuracy of the appraisal value from an outside appraiser. Moreover, though this process, system 10 may re-evaluate the appraisal datasets on an approximately real-time or concurrent time basis to generate an approximately real-time or concurrent time appraisal value based on appraisal values issuing throughout the world.

Ranking Methods

System 10 may further apply a ranking system, which may or may not include a prioritization to buy, sell or trade, which may include a review or evaluation of all coins owned or tracked by system 10, and a ranking based upon their value by comparing some or any of the following and previous exemplary factors, such as mintage, precious metal content, collector premium, foreign exchange rate of USD to foreign currency of coin's country of origin (country for which it was minted), and/or real time bullion pricing of underlying precious metals.

By using these types of factors, coins may be valued according to formulae such as the following:

Market Price of Coin=(PM content×BP of PM)+CP

Where PM is “Precious Metal”; BP is “Bullion Price”; and CP is Collector Premium, and where:

CP=Market Price of Coin−BP×PM content

These formulae may optionally take into account the fineness of the coin as defined by the percent of weight of coin in precious metal or precious metals to the total weight of coin.

Based on these valuation and ranking methodologies, system 10 may determine which coins to purchase and sell, and include in pools 24, in real time. System 10 may also utilized the aforementioned valuation and ranking methodologies to obtain and generate future value forecasts of the coin, such that system 10 may utilize any sort of futures, options or other derivative trading instrument.

Physicality of Coins

As with all precious coins, the inherent value of the coin lies in its physical possession. Therefore, when necessary, physical coins may be stored at physical storage facilities 16, such as a bank, and preferably by a bank that is a COMEX approved storage facility. As mentioned previously, master server 12 may be communicatively connected to physical storage facilities 16, such that ownership or any other updateable information may be transferred between master server 12 and physical storage facilities 16.

As used herein, a pool may be defined as any type of investable grouping that comprises at least one investable item. By non-limiting example, a pool may be an exchange traded fund (ETF), a closed end fund, an exchange-traded grantor trust, private investment partnership, public LP, mutual fund, or any other vehicle suitable for representing an investable interest in a grouped asset pool. As used herein, an ETF is a bundle of indexed items, and as such includes any fund that tracks an index and that can be traded like a stock. As used herein, a closed end fund is a fund with a fixed number of shares outstanding, and in which those outstanding shares are atypically redeemable. As used herein, an exchange traded grantor trust holds a fixed portfolio of assets and issues shares based on the value of those assets, but does not track an index.

More specifically, the present invention may, as discussed immediately hereinabove, be operable as a private fund. Exemplary embodiments of such private funds may include a limited partnership, a trust, a limited liability company, or a corporation. In each such example, the pool investor will possess a fractional, undivided interest in the entirety, but not in each of the respective underlying assets. Further, although a management fee is available to the pool manager in such a scenario, SEC limitations on transaction-based compensation, broker-dealer relationships, finder's fees, and compensation would be in effect. In this exemplary embodiment of a private fund or company, those skilled in the art will appreciate that the fund or company may sell its own securities without an underwriter/broker dealer. Finally, although a private fund is typically a low cost to open, and can be converted to a registered fund, such a private find would have placed thereon advertising restrictions, and have available a more limited pool of investors, as would be appreciated by those skilled in the art.

On the other hand, the present invention may, in certain exemplary embodiments as discussed immediately hereinabove, be operable as a registered fund. Exemplary embodiments of such registered funds may include a trust, a limited liability company, or a corporation. In each such example, the pool investors, who may typically comprise the general public through, for example, an exchange, will possess a fractional, undivided interest in the entirety, but not in each of the respective underlying assets. Further, although a management fee is available to the pool manager in such a scenario, SEC limitations on transaction-based compensation, broker-dealer relationships, finder's fees, and compensation would be in effect, and the SEC would require an underwriter. Finally, a registered, closed end fund is typically a high cost option, and has myriad attendant reporting requirements. However, such a fund is advantageous in that it is typically not subject to advertising restrictions, and makes available a large pool of investors.

Yet further, the present invention may, as discussed immediately hereinabove, be operable as a registered operating company. Exemplary embodiments of such registered operating companies may include a limited liability company or a corporation. In each such example, the pool investors, who may typically comprise the general public through, for example, an exchange, will possess a fractional, undivided interest in the entirety, but not in each of the respective underlying assets. Further, SEC limitations on transaction-based compensation, broker-dealer relationships, finder's fees, and compensation would be in effect, and the SEC would require an underwriter. Finally, a registered operating company is typically a high cost option, and has myriad attendant reporting requirements. However, such a fund is advantageous in that it is typically subject only to limited advertising restrictions, and makes available a large pool of investors.

Each pool may vary in scope, size, value and relatedness. Each pool may designate a rule or set of rules restricting the type of coin that may be held by the pool. For example, a particular pool may be restricted to a certain type of precious metal or metal combinations, such as pure precious metal, bi-metal; alloy or clad. In another example, the pool may be restricted to a certain country of origin in which or for which it was minted. In yet another example, a pool may be restricted to a denomination or face value of coin, such as 5 Euro, 1 Dollar (US), $250 CAD (Canadian Dollar), 1000 Francs (Rwanda) or 25 Pesos (Mexico). Pools may be restricted by the weight of each coin, such as 1 ozt, 5 ozt, 10 ozt, or any other measurable weight. Further still, pools may be restricted by physical characteristics of the coin, such as having a high relief vs. a normal relief, double thickness vs. standard thickness, piedfort vs. non-piedfort, proof coinage or uncirculated coinage, for example. As used herein, “piedfort” refers to a coin having twice the normal weight of a coin having generally the same size, shape and diameter. Still other restrictions may be based on age of the coin, or the year that coin was minted, or the various grade and/or rating of each coin. Restrictions may also be based on image or subject matter of each coin, such as national monuments, animals, political figures, national events and commemoratives. Further still, pools may be restricted based on art, history and/or cultural significance of each coin, such as a 2008 Chanel coin from the French Mint. Pools may also be restricted based on exclusive ownership of the pool. It should be appreciated that any given pool can utilize any such restrictive rule or rules in any combination, or alternatively may not have any restrictive rule, and can be delineated within a representative computer software program as disclosed in the present invention.

Each pool 24 may be classified by a number of various rules, as described above, wherein the rules define what coins or types of coins may he held in the pool. By having defined rules, these pools become definable investment opportunities that provide different interests and/or risk levels to those investors seeking to own a portion of a coin collection without having to physically possess the particular coins. The rules defining each pool can be of any sort, even to the exclusion of rules, as explained above, such that the pool manager has ultimate freedom to manage the pool without restriction. Each pool classification may created by system 10 and stored in the system 10 database. Each pool 24 created by system 10 will preferably also have its corresponding investment policy stored by system 10. Representative investment policies will identify and provide various levels of risk associated with the pool (varying from none to high).

System 10 may further offer pools 24 through any marketing strategy as may be understood by those skilled in the art, provided such marketing is in compliance with any laws governing the marketing and sale of tradable financial instruments. For example, a communication may be created by system 10 to subscribers or members of system 10, or to any individual or entities including coin investors, notifying them that a particular coin or coin pool will soon be available through a system 10 offering. Alternatively, the communication may be sent to brokers. To the extent necessary, an appropriate prospectus may be made available (either on-line or in paper format) to the prospective investor for review prior to purchase.

According to another aspect of the present invention, system 10 may create a certain number of ownership interests corresponding to each pool 24. System 10 may then create an initial price per interest of ownership for the pool. Because system 10 initially establishes a set number of ownership interests corresponding to the pool, each pool may be limited to a pre-defined number of ownership interests as defined by system 10. This means that system 10, with input from the pool manager, may create a limited number of investors for any particular pool. In certain embodiments, the number of interests may not be limited, such as the number of interests increasing as the size of the pool grows. In other embodiments, system 10 may allow a single investor to own all interests in a pool, particularly when the pool is limited to a smaller number or smaller value of coin holdings. In certain embodiments, the pool may consist of a single coin. In yet other embodiments, system 10 may be used by an individual or entity to hold their coins and create a private pool owned exclusively by that individual or entity. In such a case, the individual or entity may optionally include a pool manager, if desired.

User Accounts and the Exchange Platform

Because system 10 may potentially communicate with any other networked computer, system 10 may provide an avenue for a private coin holder to place a coin up for sale to system 10 managers. Further, system 10 may allow for the real-time exchange of ownership interests in pools 24. In this manner, coin holders, subscribers 20 or other owners of pool 24 interests, or any other people or entities may register with system 10 to have a membership level access to the information available via system 10. Therefore, system 10 may incorporate user accounts for screening users before allowing any particular user to become a registered subscriber. In one embodiment, system 10 may employ a secure login or subscription process, so that only approved users of the system may access system 10 information. In one exemplary embodiment, system 10 is adapted to provide a login or subscription process, and upon financial verification and payment, allow a user to access system 10 data.

System 10 may set the price per interest being offered, either directly based on the valuation methodologies as described herein, or in combination with input from a pool manager. In certain embodiments, once all ownership interests are purchased, no other ownership interests will be available, unless the number of interests is not limited, as may be the case in certain embodiments. If a potential investor desires to purchase into a pool that is already completely owned, the potential investor may enter a buy order via system 10 and wait until system 10 accepts instructions from a coin owner of his desire to sell a corresponding interest in the pool. In effect, system 10 may function as a trading platform, where verified subscribers and the various pool managers may enter “buy” and “sell” orders for the various pool interests. System 10 may further modify the price per interest in real time not only as the calculated value for the pools fluctuate, but also as a function of the demand for the pool interests. System 10 may also allow pool managers to buy and sell individual coins in the same manner as described above. It should be appreciated that system 10 may either require subscriber accounts to have sufficient funding to perform any buy/sell transaction, or alternatively, include a verification mechanism by which system 10 can rely on the ability for a particular subscriber to sufficiently fill any particular buy/sell order. System 10 may incorporate any financial accounting mechanism for its subscribers as is understood by those skilled in the art.

In another embodiment, system 10 may require a limited time period for ownership for each pool, such that ownership interests are locked or restricted, or alternatively provide for penalties for not holding a particular pool interest for a pre-defined period of time.

System 10 may execute buy and sell orders and corresponding order income and payments from subscribing investors in real time. Transactions, incomes and payments may be made via the world wide network.

System 10 may allow subscribers to access their account information, place trading orders, and view limited information pertaining to pools and those coin holdings monitored by system 10. System 10 may further provide a risk assessment report for risk tolerance for subscribers and pool managers with an evaluation of all influences of risk in each coin held, and in each pool. System 10 may further track investment term expiration, generate liquidation reports for any pool, and provide information relating to tax benefits, incentives or obligations for each pool and/or each coin held. System 10 may also post electronic fund credit and all of the processes and governmental data filing requirements for the SEC, if relevant. System 10 may keep track of individual coins within every pool, the accuracy of which is critical for investors and insurance policies.

It should be appreciated that, like any other market system, the present value of any particular pool or individual coin may primarily become a function of the market, and secondarily be a function of the estimated or appraised value of the held coins. Therefore, system 10 may also continuously track pool values, which may become market driven in real time. In other words, the coin or pool may be valued by subscribers at a rate which differs from the calculated value rates being generated at any certain time. The time to achieve a market driven value may vary, such as by seconds or on the order of days, weeks, or years. System 10 may therefore maintain and track the value of each pool, and identify any trend when a certain pool is becoming valued at a market driven approach. System 10 may continuously compare all collected and updated information for a particular coin or pool with current market driven values in approximately real time to thereby generate dynamic market information which can be electronically transmitted to system 10 subscribers and pool managers.

According to another aspect of the present invention, system 10 may provide pool managers the ability to transfer or switch ownership interests between pools. At some point in time, a particular pool may become less popular, so that the trend value of each ownership interest for the pool decreases. In this event, either system 10 or the pool manager may decide to buy, sell, transfer or switch ownership interests to increase the value of the pool interests.

In a preferred embodiment, a pool will obtain popularity amongst subscribers or pool managers who desire to buy ownership interests in the pool, thereby creating more market driven values, and necessarily increasing the market to exchange ownership interests. In another embodiment, system 10 may monitor pools or individual coins and classify particular ones with ratings based on market trends, such as “hot” or “cold”.

System 10 may incorporate any sort and number of triggering events, to initiate or discontinue a particular automated action. For example, as with any market system, “buy” and “sell” transactions can be prescheduled, and initiated based on any number of parameters. Such parameters may be, by way of non limiting example, a percent change in calculated value or of market value, upon receipt of an information item via the web crawling function, or based on any other primary or secondary market feature.

As can be appreciated by those skilled in the art, one indicator of risk is a statistical measure called “beta.” In the tradition stock trading markets, beta is used to measure the risk of a stock by measuring the volatility of the stock in relation to the market. Because the larger market is designated as having a beta of 1.0, individual stocks are ranked according to how much they deviate from the market. Therefore, a stock that swings more than the market over time has a beta above 1.0. whereas stock that moves less than the market has a beta less than 1.0. By general analysis, a higher beta stock carries more risk, but may provide a potential for higher returns. Likewise, low-beta stocks pose less risk and consequently lower returns. As used herein, each coin, as well as each pool, may carry a beta value for potential investing subscribing investors and pool managers to gauge the risk for the underlying coin or pool interest. System 10 may therefore utilize all collected information, including market data, to delineate and classify the risk levels associated with each coin pool based upon the pool's past volatility.

In an exemplary embodiment of the present invention as described herein, system 10 may function as a computerized arbitrage system. For example, if a particular precious metal price rises, or the dollar weakens, or, for example, an award is given, the coin is sold out, or any one of the quantitative and/or qualitative factors as mentioned hereinthoughout occurs, system 10 takes this information into account and updates all information databases, and may further advise any and all pool 24 managers to buy coins made of that metal, or coins from any country against whose currency the dollar has fallen.

Additionally, as referenced generally hereinabove, there is a high correlation between a particular coin winning an award, and a value increase for that coin. In another exemplary embodiment of the present invention as described herein, the web crawler of system 10 may populate a relational database any time it finds an award associated with a particular coin. Based on historical information, system 10 will know that when a coin in Japan wins an award, it will typically experience a two fold increase in value within a 48 hour period. As such, system 10 may take advantage of the real-time collection of this information, and based on the time difference, the next overnight in Japan (i.e. the next business day in the US), that coin will be an optimized, as “hot” or a high value “buy” for a pool 24, until the expiration of the 48 hours, at which time it will reach peak value and will be signaled by system 12 as a “sell,” or “not buy,” for pool 24. It should be appreciated that any order type, such as buy, hold, buy and hold, not buy, sell, or other fast trading term may be incorporated as would be understood by one skilled in the art.

It should be appreciated that there may be circumstances which require the special processing of transactions, orders or payments relating to the pools or coins due to legal restrictions or other similar restrictions. In certain situations, system 10 may thus be adapted to process or otherwise authenticate identification of the subscriber, verify the subscriber's ability to purchase or transact business with system 10, and, if authentication and identification is confirmed, process and confirm the investor's order, which may include allowing system 10 to generate and/or electronically or otherwise transmit a certification of pool ownership interest to the subscriber. If this verification process is unsuccessful, the order should not be processed nor confirmed. Such verification can also be used to determine whether the subscriber has previously transacted business via system 10, or if the subscriber is a validated member due to a prior transaction via system 10. Of course, such verifications should fully comply with applicable local, state and federal regulations.

System 10 may manage clerical operations, such as verification of orders, verification of signatures, verification of endorsements, order confirmation, payment confirmation, deposit of order funds, confirmation with the subscriber's banking source, clearing and settlement of payment funds with the banking source, printing of receipts, printing of ownership certificates, printing of reports relating to any of the pools and the printing of any other report desired

Methodology

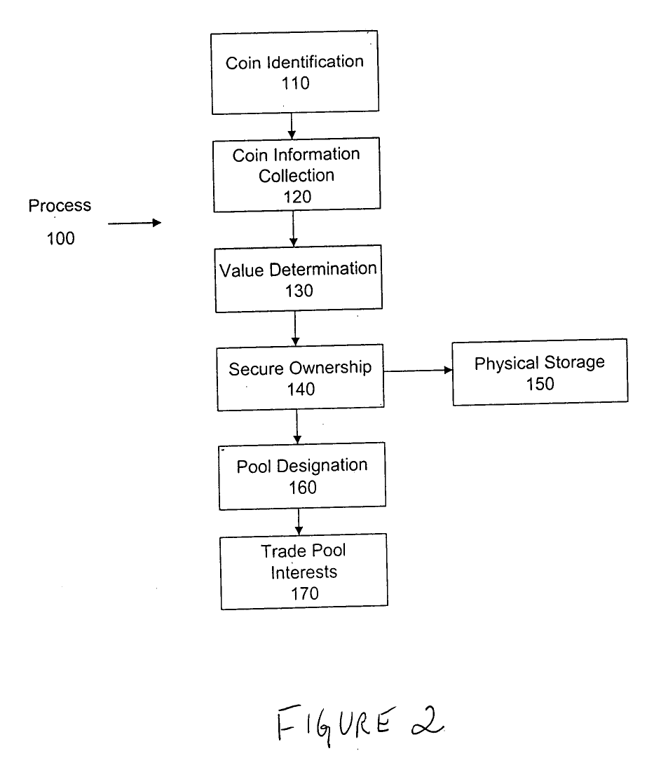

According to an aspect of the present invention, a process 100 of creating ownership rights in pools of precious coins via system 10 is provided. As depicted in FIG. 2, At step 110, system 10 may identify an investable coin. In one embodiment, the investable coin may be held or owned by a coin holder, which may be, for example, an individual, an organization or other entity. Once this coin and coin holder is identified, at step 120, system 10 may collect all information necessary to evaluate the coin, such as the coin origin, physical characteristics, past appraisal values, previous auction prices, and the like. This information may be provided by information sources 18, or any other source, such as the web crawler discussed hereinabove. At step 130, system 10 may calculate a current value for the coin, based on all of the information provided in step 120 and by the valuation methods as described herein throughout. System 10 may also verify and cross-check the appraisal information. At step 140, system 10 may secure ownership rights to the coin. This may be accomplished by any coin purchasing mechanism as understood by those skilled in the art. Step 140 may optionally include physical possession of the coin, in which case the coin may be secured at step 150 in physical storage facility 16. In either case, ownership of the coin should be perfected by any verification, certification or registration necessary for proof of ownership. At step 160, system 10 may designate a pool 24 into which the coin will be held. The determination of which pool 24 any particular coin will be held may be made by the programming of system 10 software, by any manager of pools 24 or system 10 manager, or any combination thereof. Lastly, at step 170, the pool 24 into which the coin was placed, may be offered for ownership to registered subscribers 20 via an ownership interest, as is described herein. System 10 may continuously monitor coin value against all information, including historical and new information.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

1. A computerized method for buying and selling interests in at least one coin pool, comprising:
assessing, via at least one network, at least one coin for inclusion in the at least one coin pool, wherein the at least one coin comprises at least:
constitution as legal tender in a country of origin of the at least one coin;
constitution of principally precious metals selected from the group consisting of gold, silver, platinum, palladium, and rhodium;
and comprises at least one of:
international mintage of no more than about 10,000;
national mintage limit of at least one of no more than a predetermined threshold mintage and a production limit in a certain timeframe;
a non-business strike;
a non-bullion;
a gradation of quality selected from the group consisting of proof, proof-like, specimen quality and brilliant uncirculated;
valuing, via at least one database, the at least one coin for a buy in accordance with at least one of a currency exchange value, an award, and a projected value increase;
purchasing the at least one coin and placing the at least one coin into the at least one pool in accordance with said assessing and said valuing; and
offering the interests in accordance with said purchasing.

2. The computerized method of claim 1, wherein the coin comprises an investable coin.

3. The computerized method of claim 1, wherein said purchasing comprises purchasing from a third party coin holder.

4. The computerized method of claim 3, wherein the third party coin holder comprises an individual.

5. The computerized method of claim 1, wherein said valuing comprises temporarily recommending said purchasing in accordance with at least one current circumstances.

6. The computerized method of claim 1, wherein said valuing is additionally in accordance with at least one selected from coin origin, physical characteristics, past appraisal values, and previous auction prices.

7. The computerized method of claim 1, further comprising populating the at least one database via at least one of a web crawler, a spider search, a keyword search, and an RSS feed library.

8. The computerized method of claim 1, further comprising verifying said valuing.

9. The computerized method of claim 1, further comprising physically holding the at least one coin after said purchasing.

10. The computerized method of claim 1, wherein said purchasing comprises perfecting ownership.

11. The computerized method of claim 1, further comprising designating the pool from among a plurality of pools upon said purchasing.

12. The computerized method of claim 11, wherein said designating comprises determining one or more characteristics of the coin, and electronically correlating said determining with each of the plurality of pools.

13. The computerized method of claim 1, wherein the interests comprise an indivisible percentage ownership.

14. The computerized method of claim 1, wherein said offering comprises offering solely to subscribers.

15. of claim 14, further comprising registering a plurality of subscribers via the at least one network.

16. A system for buying and selling interests in at least one coin pool over a computer network, comprising:
at least one network over which at least one coin is assessed for inclusion in the at least one coin pool,
wherein the at least one coin comprises at least:
constitution as legal tender in at least one country;
constitution of principally precious metals selected from the group consisting of gold, silver, platinum, palladium, and rhodium;
and comprises at least one of:
international mintage of no more than about 10,000;
national mintage limit of at least one of no more than a predetermined threshold mintage and a production limit in a certain timeframe;
a non-business strike;
a non-bullion;
a gradation of quality selected from the group consisting of proof, proof-like, specimen quality and brilliant uncirculated;
at least one database for valuing the at least one coin for a buy in accordance with at least one of a currency exchange value, an award, and a projected value increase;
at least one coin purchased and placed into the at least one pool in accordance with the assessment and valuation; and
at least one interest in the at least one pool, in accordance with the purchased coin.

17. The system of claim 16, wherein the coin comprises an investable coin.

18. The system of claim 16, wherein the coin is purchased from a third party coin holder.

19. The system of claim 18, wherein the third party coin holder comprises an individual.

20. The system of claim 16, wherein the valuation comprises temporarily recommending said purchase in accordance with at least one current circumstance.
